(19) United States
(12) Patent Application Publication
(10) Pub. No.: US 2017/0208394 A1
(43) Pub. Date: Jul. 20, 2017

(54) CHANNEL CONFIGURATION METHOD AND APPARATUS AND USER EQUIPMENT

(71) Applicant: Beijing Zhigu Rui Tuo Tech Co., Ltd, Beijing (CN)

(72) Inventors: Ran XU, Beijing (CN); Wei SHI, Beijing (CN)

(21) Appl. No.: 15/326,453

(22) PCT Filed: Jul. 9, 2015
(86) PCT No.: PCT/CN2015/083640

§ 371 Date: Jan. 13, 2017

(30) Foreign Application Priority Data
Jul. 18, 2014 (CN) 201410345047.1

(51) Int. Cl. H04R 5/04; H04R 1/10; H04R 5/033

(52) U.S. Cl. CPC H04R 5/04; H04R 5/033; H04R 1/1041; H04R 2420/07

(57) ABSTRACT

A channel configuration method and apparatus and a user equipment are provided. A method comprises: acquiring at least one related attribute of a wireless communication distance from each of two earpieces in pair to a reference device; and performing a channel configuration on audio signals of the two earpieces at least according to the at least one related attribute of the wireless communication distance and a bearing of the reference device relative to a user body wearing the two earpieces. The embodiments of this application thus provide channel configuration solution(s).

### RELATED APPLICATION

The present international patent cooperative treaty (PCT) application claims the benefit of priority to Chinese Patent Application No. 201410345047.1, filed on Jul. 18, 2014, and entitled “Channel Configuration Method and Apparatus and User Equipment”, which is hereby incorporated into the present international PCT application by reference herein in its entirety.

### TECHNICAL FIELD

Embodiments of this application relate to the field of electronic technologies, and in particular, to a channel configuration method and apparatus and a user equipment.

### BACKGROUND

A conventional earphone device generally comprises two earpieces in pair, where one is a left earpiece and the other is a right earpiece; and channels of signals of the left earpiece and the right earpiece are respectively a left channel and a right channel. In order to distinguish the left earpiece and the right earpiece, a letter L indicating left and a letter R indicating right are generally printed on the two earpieces separately or shapes of the two earpieces are separately designed to be suitable for a left ear or a right ear.

Even so, a user may still wear the left earpiece and the right earpiece oppositely, leading to poor experience of earpiece signals.

### SUMMARY

In view of this, an example objective of one or more embodiments of this application is to provide channel configuration solutions.

Related to the foregoing objective, according to an aspect of example embodiments of this application, a channel configuration method is provided, comprising:
acquiring at least one related attribute of a wireless communication distance from each of two earpieces in pair to a reference device; and
performing a channel configuration on audio signals of the two earpieces at least according to the at least one related attribute of the wireless communication distance and a bearing of the reference device relative to a user body wearing the two earpieces.

Related to the foregoing objective, according to another aspect of example embodiments of this application, a channel configuration apparatus is provided, comprising:
an attribute acquisition module, configured to acquire at least one related attribute of a wireless communication distance from each of two earpieces in pair to a reference device; and
a channel configuration module, configured to perform a channel configuration on audio signals of the two earpieces at least according to the at least one related attribute of the wireless communication distance and a bearing of the reference device relative to a user body wearing the two earpieces.

Related to the foregoing objective, according to still another aspect of example embodiments of this application, a user equipment is provided, comprising: the channel configuration apparatus as described above.

At least one technical solution in the foregoing technical solutions has the following beneficial effect(s):

One or more of the embodiments of this application provide a channel configuration solution: acquiring at least one related attribute of a wireless communication distance from each of two earpieces in pair to a reference device; and performing a channel configuration on audio signals of the two earpieces at least according to the at least one related attribute of the wireless communication distance and a bearing of the reference device relative to a user body wearing the two earpieces.

### BRIEF DESCRIPTION OF THE DRAWINGS

FIG. 1 is a schematic flowchart of an example embodiment of a channel configuration method according to this application;

FIG. 2A and FIG. 2B are respectively an example schematic time domain diagram and an example schematic frequency domain diagram of CSI of a wireless communication channel between an earpiece A and a reference device in this application;

FIG. 2C and FIG. 2D are respectively an example schematic time domain diagram and an example schematic frequency domain diagram of CSI of a wireless communication channel between an earpiece B and a reference device in this application;

FIG. 3A is a schematic structural diagram of an example embodiment of a channel configuration apparatus according to this application;

FIG. 3B and FIG. 3C are separately schematic structural diagrams of an example embodiment shown in FIG. 3A;

FIG. 4 is a schematic structural diagram of another example embodiment of a channel configuration apparatus according to this application;

FIG. 5A is a schematic structural diagram of an example embodiment of a user equipment according to this application; and

FIG. 5B is a schematic structural diagram of an example embodiment shown in FIG. 5A.

### DETAILED DESCRIPTION

Example embodiments of this application are further described in detail below with reference to the accompanying drawings and embodiments. The following embodiments are intended to describe this application, but not to limit the scope of this application.

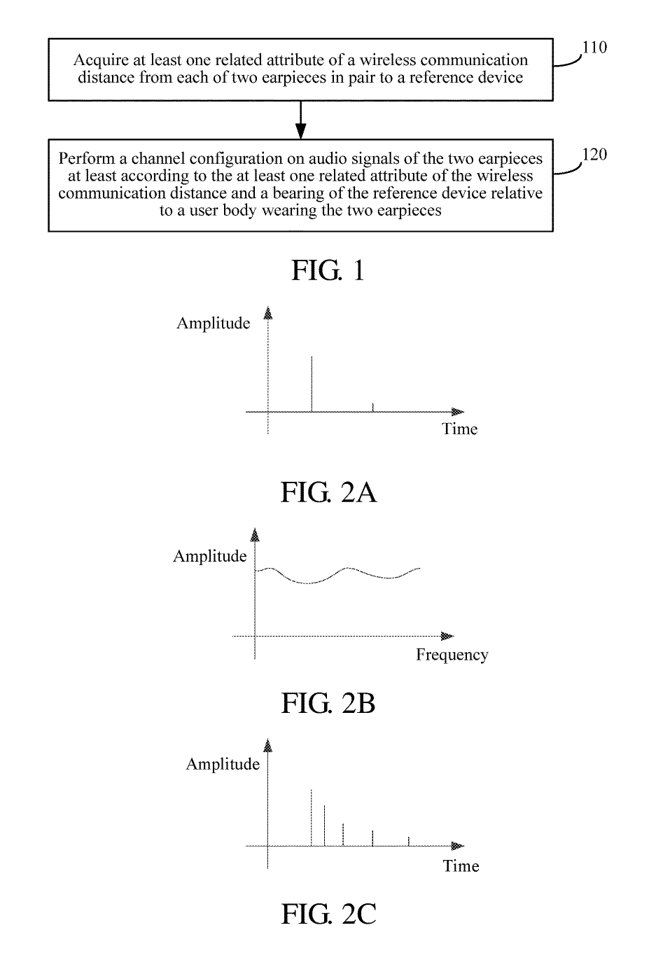

FIG. 1 is a schematic flowchart of an example embodiment of a channel configuration method according to this application. As shown in FIG. 1, this embodiment comprises:

110. Acquire at least one related attribute of a wireless communication distance from each of two earpieces in pair to a reference device.

For example, a channel configuration apparatus provided in this application acts as an entity for executing this embodiment, to execute 110 to 120. Specifically, the channel configuration apparatus may be disposed in an audio output device, an audio input device, or an earphone device comprising the two earpieces in a software manner, a hardware manner, or a manner of a combination of software and hardware. The earphone device may be a wireless earphone device, that is, the earphone device may exchange audio signals with the audio output device or the audio input device in a wireless manner; or the earphone device may also be a wired earphone device, that is, the earphone device may exchange audio signals with the audio output device or the audio input device in a wired manner. The audio output device or the audio input device may be a device such as a mobile phone, a tablet computer, an MP3 player, a smart wrist strap or smart glasses, which can output or input audio, and the audio output device or the audio input device may exchange audio signals with the two earpieces in a wireless or wired manner.

In this embodiment, the related attribute of the wireless communication distance refers to an attribute related to a wireless communication distance, and correspondingly, the attribute can reflect an amount of the wireless communication distance. Specifically, the at least one related attribute of the wireless communication distance separately from the two earpieces to the reference device can separately reflect an amount of the wireless communication distance from a corresponding earpiece to the reference device. For example, the two earpieces is an earpiece A and an earpiece B, at least one related attribute of a wireless communication distance from the earpiece A to the reference device and at least one related attribute of a wireless communication distance from the earpiece B to the reference device are compared, so that it can be determined which of the wireless communication distance between the earpiece A and the reference device and the wireless communication distance between the earpiece B and the reference device is large or which is small, that is, it can be determined whether the earpiece A is nearer to the reference device, or the earpiece B is nearer to the reference device.

120. Perform a channel configuration on audio signals of the two earpieces at least according to the at least one related attribute of the wireless communication distance and a bearing of the reference device relative to a user body wearing the two earpieces.

Optionally, the bearing of the reference device relative to the user body comprises, but is not limited to: the reference device being located at a left side or a right side of the user body.

Specifically, the bearing of the reference device relative to the user body may be input by a user or be obtained by measurement, which is not limited herein by this embodiment. For example, a handheld device or a wearable device used as the reference device may measure whether itself is held or is worn on a left arm or a right arm of the user body, and when itself is held or is worn on the left arm of the user body, it may be considered that itself is usually located at the left side of the user body; or when itself is held or is worn on the right arm of the user body, it may be considered that itself is usually located at the right side of the user body.

Optionally, the performing a channel configuration on audio signals of the two earpieces comprises: separately configuring the audio signal channels of the two earpieces as a left channel and a right channel. There are many manners to separately configure the audio signal channels of the two earpieces as a left channel and a right channel. Using that the channel configuration apparatus is disposed in the earphone device as an example, the choice of an input/output path can be implemented based on a default input/output channel configuration of an audio signal and a channel switching circuit, thereby implementing different channel configurations. Using that the channel configuration apparatus is disposed in the audio output/input device as an example, the choice of an output/input path can be implemented based on a default output/input channel configuration of an audio signal and a channel switching circuit, thereby implementing different channel configurations. Alternatively, different channel configurations are implemented by interchanging content of audio signals transmitted in the channels.

This embodiment provides a channel configuration solution: acquiring at least one related attribute of a wireless communication distance from each of two earpieces in pair to a reference device; and performing a channel configuration on audio signals of the two earpieces at least according to the at least one related attribute of the wireless communication distance and a bearing of the reference device relative to a user body wearing the two earpieces.

The method of this embodiment is further described below by using some example embodiments.

In this embodiment, the related attribute of the wireless communication distance may have many types. Optionally, the at least one related attribute of the wireless communication distance comprises, but is not limited to at least one of the following: a received signal strength indication (RSSI) relative to the same emission power, a round trip delay (RTD), and channel state information (CSI).

The RSSI relative to the same emission power identifies signal strength, at a receiving end, of signals transmitted at the same emission power. Signal strength of a wireless signal is attenuated to some extent during transmission, and the degree of attenuation is related to a distance a wireless signal is transmitted, that is, the degree of attenuation is related to a wireless communication distance between an earpiece and the reference device. In a possible scenario, each of the two earpieces sends a wireless signal at the same emission power, and the reference device separately receives these two wireless signals sent by the two earpieces. Optionally, if wireless communication distances from the two earpieces to the reference device are different, signal strength of the wireless signals separately sent by the two earpieces is attenuated to different degrees during processes of reaching the reference device, and correspondingly, the signal strength of these two wireless signals received by the reference device is different, that is, RSSIs relative to the same emission power are different. In another possible scenario, the reference device sends a wireless signal at certain emission power, and the two earpieces separately receive the wireless signal. Optionally, if wireless communication distances from the reference device to the two earpieces are different, signal strength of the wireless signal is attenuated to different degrees during processes of reaching the two earpieces separately, and correspondingly, the signal strength of the wireless signal separately received by the two earpieces is different, that is, RSSIs relative to the same emission power are different.

The RTD refers to a time for which a wireless signal is transmitted back and forth between each earpiece and the reference device, and is related to a wireless communication distance between an earpiece and the reference device. In a possible scenario, each of the two earpieces sends a request signal, and records a time for sending the request signal. The reference device separately sends a corresponding response signal after receiving each of the request signals. Each of the two earpieces records a time for receiving the response signal corresponding to the request signal sent by itself, and determines an RTD from itself to the reference device according to the time for sending the request signal time and the time for receiving the response signal corresponding to the request signal. Optionally, if wireless communication distances from the two earpieces to the reference device are different, a distance that a wireless signal is transmitted back and forth between each earpiece and the reference device is different, and correspondingly, a delay that the wireless signal is transmitted back and forth between each earpiece and the reference device is different, that is, RTDs are different. In another possible scenario, the reference device broadcasts a request signal, and records a time for broadcasting the request signal. Each of the two earpieces sends a response signal after receiving the request signal. The reference device separately records a time for receiving the response signal sent by each of the two earpieces, and determines an RTD from each of the two earpieces to itself according to the time for broadcasting the request signal time and the time for receiving the response signal sent by each of the two earpieces. Optionally, if wireless communication distances from the two earpieces to the reference device are different, a distance that a wireless signal is transmitted back and forth between each earpiece and the reference device is different, and correspondingly, a delay that the wireless signal is transmitted back and forth between each earpiece and the reference device is different, that is, RTDs are different.

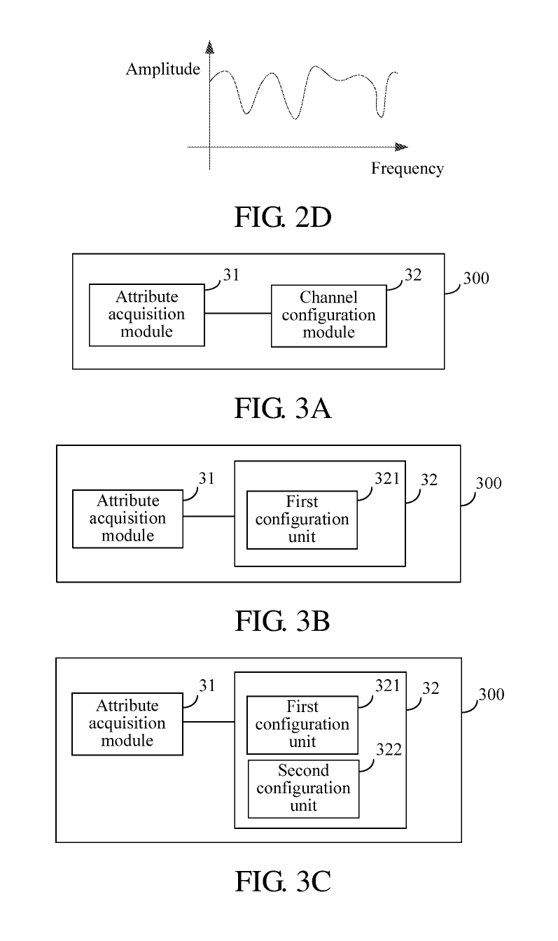

The CSI refers to an attribute of a wireless communication channel between each earpiece and the reference device. Usually, the CSI describes a degree to which a wireless signal fades on a channel, and the degree of fading is related to a wireless communication distance from an earpiece to the reference device. Specifically, when a wireless communication distance is longer, a multipath effect is more obvious, and the multipath effect is represented in a frequency domain as a fluctuation of an amplitude-frequency curve, and is represented in a time domain as the number and distribution of impulse responses. It is assumed that the two earpieces comprise an earpiece A and an earpiece B. FIG. 2A and FIG. 2B are respectively a schematic time domain diagram and a schematic frequency domain diagram of CSI of a wireless communication channel between the earpiece A and the reference device in this application; and FIG. 2C and FIG. 2D are respectively a schematic time domain diagram and a schematic frequency domain diagram of CSI of a wireless communication channel between the earpiece B and the reference device in this application. It can be seen from a contrast between FIG. 2A and FIG. 2C that impulse responses in FIG. 2A are few and are sparse in distribution, and impulse responses in FIG. 2C are many and thick in distribution. As can be seen from this, a multipath effect of the wireless communication channel corresponding to FIG. 2A is less obvious than that of FIG. 2C, and correspondingly, a wireless communication distance between the earpiece A and the reference device is smaller than a wireless communication distance between the earpiece B and the reference device. Similarly, it can be seen from a contrast between FIG. 2B and FIG. 2D that a fluctuation of a curve in FIG. 2B is small, and a fluctuation of a curve in FIG. 2D is large. As can be seen from this, a multipath effect of the wireless communication channel corresponding to FIG. 2B is less obvious than that of FIG. 2D, and correspondingly, a wireless communication distance between the earpiece A and the reference device is smaller than a wireless communication distance between the earpiece B and the reference device.

For ease of a contrast, the at least one related attribute of the wireless communication distance from each of the two earpieces to the reference device comprises at least one related attribute of the wireless communication distance, of the same type. For example, the two earpieces comprise an earpiece A and an earpiece B, where at least one related attribute of a wireless communication distance from the earpiece A to the reference device comprises an RTD from the earpiece A to the reference device, and correspondingly, at least one related attribute of a wireless communication distance from the earpiece B to the reference device comprises an RTD from the earpiece B to the reference device.

Optionally, in order to reduce errors, the at least one related attribute of the wireless communication distance in this embodiment is obtained by many times of measurement.

In this embodiment, because the at least one related attribute of the wireless communication distance can reflect an amount of the wireless communication distance, that is, can identify that a wireless communication distance from which earpiece in the two earpieces to the reference device is nearer, and a wireless communication distance from which earpiece to the reference device is farther. Base on this, it may be considered that an earpiece nearer to the reference device and the reference device are located at the same side of the user body, and an earpiece farther from the reference device and the reference device are located at different sides of the user body. Further, in combination with whether the reference device is located at the left side or the right side of the user body, it is determined an audio signal channel of which earpiece is configured as the left channel, and an audio signal channel of which earpiece is configured as the right channel.

In an example embodiment, the performing a channel configuration on audio signals of the two earpieces at least according to the at least one related attribute of the wireless communication distance and a bearing of the reference device relative to a user body wearing the two earpieces comprises:
in response to that the at least one related attribute of the wireless communication distance identifies that a wireless communication distance from one earpiece in the two earpieces to the reference device is nearer than a wireless communication distance from the other earpiece to the reference device, and the reference device is located at a left side of the user body, configuring an audio signal channel of the one earpiece as a left channel, and configuring an audio signal channel of the other earpiece as a right channel.

For example, the two earpieces are an earpiece A and an earpiece B. It can be seen by comparing at least one related attribute of a wireless communication distance from the earpiece A to the reference device and at least one related attribute of a wireless communication distance from the earpiece B to the reference device that, the wireless communication distance from the earpiece A to the reference device is larger than the wireless communication distance from the earpiece B to the reference device, that is, the earpiece A is father from the reference device than the earpiece B, and correspondingly, it may be considered that the earpiece A and the reference device are located at different sides of the user body, and the earpiece B and the reference device are located at the same side of the user body. Further, because the reference device is located at the left side of the user body, an audio signal channel of the earpiece B located, the same as the reference device, at the left side of the user body is configured as the left channel, and an audio signal channel of the earpiece A located at a side different from the reference device, of the user body, that is, the earpiece A located at the right side of the user body, is configured as the right channel.

In another example embodiment, the performing a channel configuration on audio signals of the two earpieces at least according to the at least one related attribute of the wireless communication distance and a bearing of the reference device relative to a user body wearing the two earpieces comprises:
in response to that the at least one related attribute of the wireless communication distance identifies that a wireless communication distance from one earpiece in the two earpieces to the reference device is nearer than a wireless communication distance from the other earpiece to the reference device, and the reference device is located at a right side of the user body, configuring an audio signal channel of the one earpiece as a right channel, and configuring an audio signal channel of the other earpiece as a left channel.

For example, the two earpieces are an earpiece A and an earpiece B. It can be seen by comparing at least one related attribute of a wireless communication distance from the earpiece A to the reference device and at least one related attribute of a wireless communication distance from the earpiece B to the reference device that, the wireless communication distance from the earpiece A to the reference device is larger than the wireless communication distance from the earpiece B to the reference device, that is, the earpiece A is father from the reference device than the earpiece B, and correspondingly, it may be considered that the earpiece A and the reference device are located at different sides of the user body, and the earpiece B and the reference device are located at the same side of the user body. Further, because the reference device is located at the right side of the user body, an audio signal channel of the earpiece B located, the same as the reference device, at the right side of the user body is configured as the right channel, and an audio signal channel of the earpiece A located at a side different from the reference device, of the user body, that is, the earpiece A located at the left side of the user body, is configured as the left channel.

In this embodiment, the reference device may be any device whose bearing relative to the user body is known.

From a perspective that the reference device and the two earpieces work cooperatively, optionally, the reference device is an audio output device or an audio input device. Specifically, when the reference device is an audio output device, the reference device outputs, optionally according to channel configurations of the audio signals of the two earpieces, audio signals of a left channel and audio signals of a right channel separately to the two earpieces; or when the reference device is an audio input device, the reference device determines, optionally according to channel configurations of the audio signals of the two earpieces, which of the audio signals separately input from the two earpieces is audio signals of a left channel, and which is audio signals of a right channel.

From a perspective of a device type, optionally, the reference device is a handheld device or a wearable device. Specifically, the handheld device comprises, but is not limited to: a mobile phone, a tablet computer, an MP3 player, or the like; and the wearable device comprises, but is not limited to: a smart wrist strap, smart glasses, or the like.

FIG. 3A is a schematic structural diagram of Embodiment 1 of a channel configuration apparatus according to this application. As shown in FIG. 3A, a channel configuration apparatus (the apparatus for short below) 300 comprises:
an attribute acquisition module 31, configured to acquire at least one related attribute of a wireless communication distance from each of two earpieces in pair to a reference device; and
a channel configuration module 32, configured to perform a channel configuration on audio signals of the two earpieces at least according to the at least one related attribute of the wireless communication distance and a bearing of the reference device relative to a user body wearing the two earpieces.

The apparatus 300 of this embodiment may be disposed in an audio output device, an audio input device, or an earphone device comprising the two earpieces in a software manner, a hardware manner, or a manner of a combination of software and hardware. The earphone device may be a wireless earphone device, that is, the earphone device may exchange audio signals with the audio output device or the audio input device in a wireless manner; or the earphone device may also be a wired earphone device, that is, the earphone device may exchange audio signals with the audio output device or the audio input device in a wired manner. The audio output device or the audio input device may be a device such as a mobile phone, a tablet computer, an MP3 player, a smart wrist strap or smart glasses, which can output or input audio, and the audio output device or the audio input device may exchange audio signals with the two earpieces in a wireless or wired manner.

In this embodiment, the related attribute of the wireless communication distance refers to an attribute related to a wireless communication distance, and correspondingly, the attribute can reflect an amount of the wireless communication distance. Specifically, the at least one related attribute of the wireless communication distance separately from the two earpieces to the reference device can separately reflect an amount of a wireless communication distance from a corresponding earpiece to the reference device. For example, the two earpieces is an earpiece A and an earpiece B, at least one related attribute of a wireless communication distance from the earpiece A to the reference device and at least one related attribute of a wireless communication distance from the earpiece B to the reference device are compared, so that it can be determined which of the wireless communication distance between the earpiece A and the reference device and the wireless communication distance between the earpiece B and the reference device is large or which is small, that is, it can be determined whether the earpiece A is nearer to the reference device, or the earpiece B is nearer to the reference device.

Optionally, the bearing of the reference device relative to the user body comprises, but is not limited to: the reference device being located at a left side or a right side of the user body

Specifically, the bearing of the reference device relative to the user body may be input by a user or be obtained by measurement, which is not limited herein by this embodiment. For example, a handheld device or a wearable device used as the reference device may measure whether itself is held or is worn on a left arm or a right arm of the user body, and when itself is held or is worn on the left arm of the user body, it may be considered that itself is usually located at the left side of the user body; or when itself is held or is worn on the right arm of the user body, it may be considered that itself is usually located at the right side of the user body.

Optionally, the performing, by the channel configuration module 32, a channel configuration on audio signals of the two earpieces is specifically: separately configuring, by the channel configuration module 32, the audio signal channels of the two earpieces as a left channel and a right channel. There are many manners for the channel configuration module 32 to separately configure the audio signal channels of the two earpieces as a left channel and a right channel. Using that the apparatus 300 is disposed in the earphone device as an example, the channel configuration module 32 may implement, based on a default input/output channel configuration of an audio signal and a channel switching circuit, the choice of an input/output path, thereby implementing different channel configurations. Using that the apparatus 300 is disposed in the audio output/input device as an example, the channel configuration module 32 may implement, based on a default output/input channel configuration of an audio signal and a channel switching circuit, the choice of an output/input path, thereby implementing different channel configurations. Alternatively, the channel configuration module 32 implements different channel configurations by interchanging content of audio signals transmitted in the channels.

The channel configuration apparatus of this embodiment provides a channel configuration solution: an attribute acquisition module acquires at least one related attribute of a wireless communication distance from each of two earpieces in pair to a reference device; and a channel configuration module performs channel configuration on audio signals of the two earpieces at least according to the at least one related attribute of the wireless communication distance and a bearing of the reference device relative to a user body wearing the two earpieces.

The apparatus 300 of this embodiment is further described below by using some example embodiments.

In this embodiment, the related attribute of the wireless communication distance may have many types. Optionally, the at least one related attribute of the wireless communication distance comprises, but is not limited to at least one of the following: an RSSI relative to the same emission power, an RTD, and CSI.

The RSSI relative to the same emission power identifies signal strength, at a receiving end, of signals transmitted at the same emission power. Signal strength of a wireless signal is attenuated to some extent during transmission, and the degree of attenuation is related to a distance a wireless signal is transmitted, that is, the degree of attenuation is related to a wireless communication distance between an earpiece and the reference device. In a possible scenario, each of the two earpieces sends a wireless signal at the same emission power, and the reference device separately receives these two wireless signals sent by the two earpieces. Optionally, if wireless communication distances from the two earpieces to the reference device are different, signal strength of the wireless signals separately sent by the two earpieces is attenuated to different degrees during processes of reaching the reference device, and correspondingly, the signal strength of these two wireless signals received by the reference device is different, that is, RSSIs relative to the same emission power are different. In another possible scenario, the reference device sends a wireless signal at certain emission power, and the two earpieces separately receive the wireless signal. Optionally, if wireless communication distances from the reference device to the two earpieces are different, signal strength of the wireless signal is attenuated to different degrees during processes of reaching the two earpieces separately, and correspondingly, the signal strength of the wireless signal separately received by the two earpieces is different, that is, RSSIs relative to the same emission power are different

The RTD refers to a time for which a wireless signal is transmitted back and forth between each earpiece and the reference device, and is related to a wireless communication distance between an earpiece and the reference device. In a possible scenario, each of the two earpieces sends a request signal, and records a time for sending the request signal. The reference device separately sends a corresponding response signal after receiving each of the request signals. Each of the two earpieces records a time for receiving the response signal corresponding to the request signal sent by itself, and determines an RTD from itself to the reference device according to the time for sending the request signal time and the time for receiving the response signal corresponding to the request signal. Optionally, if wireless communication distances from the two earpieces to the reference device are different, a distance that a wireless signal is transmitted back and forth between each earpiece and the reference device is different, and correspondingly, a delay that the wireless signal is transmitted back and forth between each earpiece and the reference device is different, that is, RTDs are different. In another possible scenario, the reference device broadcasts a request signal, and records a time for broadcasting the request signal. Each of the two earpieces sends a response signal after receiving the request signal. The reference device separately records a time for receiving the response signal sent by each of the two earpieces, and determines an RTD from each of the two earpieces to itself according to the time for broadcasting the request signal time and the time for receiving the response signal sent by each of the two earpieces. Optionally, if wireless communication distances from the two earpieces to the reference device are different, a distance that a wireless signal is transmitted back and forth between each earpiece and the reference device is different, and correspondingly, a delay that the wireless signal is transmitted back and forth between each earpiece and the reference device is different, that is, RTDs are different.

The CSI refers to an attribute of a wireless communication channel between each earpiece and the reference device. Usually, the CSI describes a degree to which a wireless signal fades on a channel, and the degree of fading is related to a wireless communication distance from an earpiece to the reference device. Specifically, when a wireless communication distance is longer, a multipath effect is more obvious, and the multipath effect is represented in a frequency domain as a fluctuation of an amplitude-frequency curve, and is represented in a time domain as the number and distribution of impulse responses. It is assumed that the two earpieces comprise an earpiece A and an earpiece B. FIG. 2A and FIG. 2B are respectively a schematic time domain diagram and a schematic frequency domain diagram of CSI of a wireless communication channel between the earpiece A and the reference device in this application; and FIG. 2C and FIG. 2D are respectively a schematic time domain diagram and a schematic frequency domain diagram of CSI of a wireless communication channel between the earpiece B and the reference device in this application. It can be seen from a contrast between FIG. 2A and FIG. 2C that impulse responses in FIG. 2A are few and are sparse in distribution, and impulse responses in FIG. 2C are many and thick in distribution. As can be seen from this, a multipath effect of the wireless communication channel corresponding to FIG. 2A is less obvious than that of FIG. 2C, and correspondingly, a wireless communication distance between the earpiece A and the reference device is smaller than a wireless communication distance between the earpiece B and the reference device. Similarly, it can be seen from a contrast between FIG. 2B and FIG. 2D that a fluctuation of a curve in FIG. 2B is small, and a fluctuation of a curve in FIG. 2D is large. As can be seen from this, a multipath effect of the wireless communication channel corresponding to FIG. 2B is less obvious than that of FIG. 2D, and correspondingly, a wireless communication distance between the earpiece A and the reference device is smaller than a wireless communication distance between the earpiece B and the reference device.

For ease of a contrast, the at least one related attribute, which is acquired by the attribute acquisition module 31, of the wireless communication distance from each of the two earpieces to the reference device comprises at least one related attribute of the wireless communication distance, of the same type. For example, the two earpieces comprise an earpiece A and an earpiece B, where at least one related attribute, which is acquired by the attribute acquisition module 31, of a wireless communication distance from the earpiece A to the reference device comprises an RTD from the earpiece A to the reference device, and correspondingly, at least one related attribute, which is acquired by the attribute acquisition module 31, of a wireless communication distance from the earpiece B to the reference device comprises an RTD from the earpiece B to the reference device.

Optionally, in order to reduce errors, the at least one related attribute of the wireless communication distance in this embodiment is obtained by many times of measurement.

In this embodiment, because the related attribute of the wireless communication distance can reflect an amount of the wireless communication distance, that is, can identify that a wireless communication distance from which earpiece in the two earpieces to the reference device is nearer, and a wireless communication distance from which earpiece to the reference device is farther. Base on this, it may be considered that an earpiece nearer to the reference device and the reference device are located at the same side of the user body, and an earpiece farther from the reference device and the reference device are located at different sides of the user body. Further, the channel configuration module 32 may determine, in combination with whether the reference device is located at the left side or the right side of the user body, an audio signal channel of which earpiece is configured as the left channel, and an audio signal channel of which earpiece is configured as the right channel.

In an example embodiment, as shown in FIG. 3B, the channel configuration module 32 comprises:
a first configuration unit 321, configured to: in response to that the at least one related attribute of the wireless communication distance identifies that a wireless communication distance from one earpiece in the two earpieces to the reference device is nearer than a wireless communication distance from the other earpiece to the reference device, and the reference device is located at a left side of the user body, configure an audio signal channel of the one earpiece as a left channel, and configure an audio signal channel of the other earpiece as a right channel.

For example, the two earpieces are an earpiece A and an earpiece B. It can be seen by comparing at least one related attribute of a wireless communication distance from the earpiece A to the reference device and at least one related attribute of a wireless communication distance from the earpiece B to the reference device that, the wireless communication distance from the earpiece A to the reference device is larger than the wireless communication distance from the earpiece B to the reference device, that is, the earpiece A is father from the reference device than the earpiece B, and correspondingly, it may be considered that the earpiece A and the reference device are located at different sides of the user body, and the earpiece B and the reference device are located at the same side of the user body. Further, because the reference device is located at the left side of the user body, the first configuration unit 321 configures an audio signal channel of the earpiece B located, the same as the reference device, at the left side of the user body as the left channel, and configures an audio signal channel of the earpiece A located at a side different from the reference device, of the user body, that is, the earpiece A located at the right side of the user body, as the right channel.

In another example embodiment, as shown in FIG. 3C, the channel configuration module 32 comprises:
a second configuration unit 322, configured to in response to that the at least one related attribute of the wireless communication distance identifies that a wireless communication distance from one earpiece in the two earpieces to the reference device is nearer than a wireless communication distance from the other earpiece to the reference device, and the reference device is located at a right side of the user body, configure an audio signal channel of the one earpiece as a right channel, and configure an audio signal channel of the other earpiece as a left channel.

For example, the two earpieces are an earpiece A and an earpiece B. It can be seen by comparing at least one related attribute of a wireless communication distance from the earpiece A to the reference device and at least one related attribute of a wireless communication distance from the earpiece B to the reference device that, the wireless communication distance from the earpiece A to the reference device is larger than the wireless communication distance from the earpiece B to the reference device, that is, the earpiece A is father from the reference device than the earpiece B, and correspondingly, it may be considered that the earpiece A and the reference device are located at different sides of the user body, and the earpiece B and the reference device are located at the same side of the user body. Further, because the reference device is located at the right side of the user body, the second configuration unit 322 configures an audio signal channel of the earpiece B located, the same as the reference device, at the right side of the user body as the right channel, and configures an audio signal channel of the earpiece A located at a side different from the reference device, of the user body, that is, the earpiece A located at the left side of the user body, as the left channel.

In this embodiment, the reference device may be any device whose bearing relative to the user body is known.

From a perspective that the reference device and the two earpieces work cooperatively, optionally, the reference device is an audio output device or an audio input device. Specifically, when the reference device is an audio output device, the reference device outputs, optionally according to channel configurations of the audio signals of the two earpieces, audio signals of a left channel and audio signals of a right channel from the two earpieces; or when the reference device is an audio input device, the reference device determines, optionally according to channel configurations of the audio signals of the two earpieces, which of the audio signals separately input from the two earpieces is audio signals of a left channel, and which one is audio signals of a right channel.

From a perspective of a device type, optionally, the reference device is a handheld device or a wearable device. Specifically, the handheld device comprises, but is not limited to: a mobile phone, a tablet computer, an MP3 player, or the like; and the wearable device comprises, but is not limited to: a smart wrist strap, smart glasses, or the like.

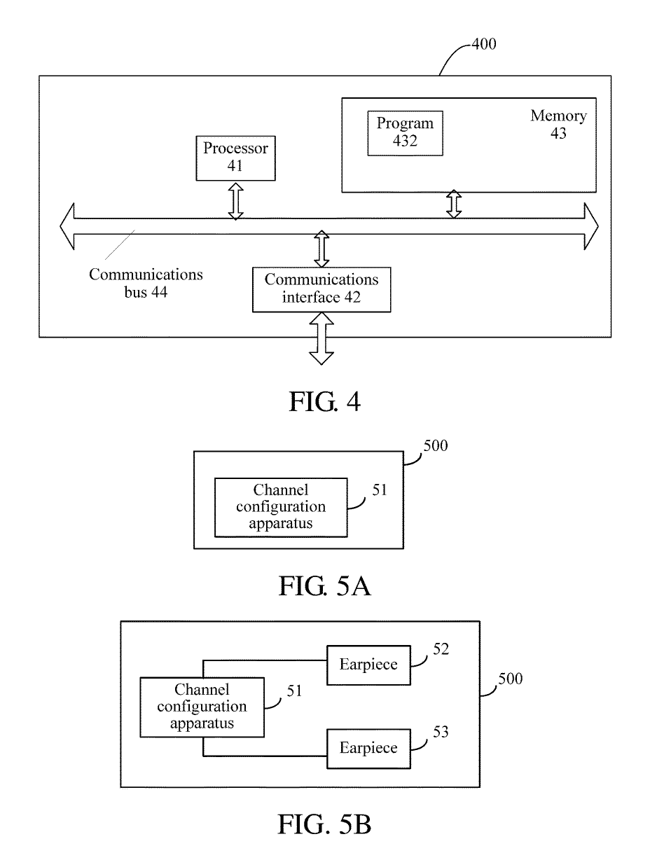

FIG. 4 is a schematic structural diagram of Embodiment 2 of a channel configuration apparatus according to this application. As shown in FIG. 4, a channel configuration apparatus 400 comprises:
a processor 41, a communications interface 42, a memory 43, and a communications bus 44.

The processor 41, the communications interface 42, and the memory 43 communicate with each other by using the communications bus 44.

The communications interface 42 is configured to communicate with an external device.

The processor 41 is configured o execute a program 432, and specifically, may perform related steps in the embodiment of the forgoing channel configuration method.

Specifically, the program 432 may comprise program code, where the program code comprises a computer operation instruction.

The processor 41 may be a central processing unit (CPU), an application specific integrated circuit (ASIC), or one or more integrated circuits configured to implement the embodiment of the channel configuration method.

The memory 43 is configured to store the program 432. The memory 43 may comprise a high-speed random access memory (RAM), and may also comprise a non-volatile memory, for example, at least one disk memory. The program 432 may be specifically configured to enable the channel configuration apparatus 400 to perform the following steps:
acquiring at least one related attribute of a wireless communication distance from each of two earpieces in pair to a reference device; and
performing a channel configuration on audio signals of the two earpieces at least according to the at least one related attribute of the wireless communication distance and a bearing of the reference device relative to a user body wearing the two earpieces.

For the specific implementation of the steps in the program 432, reference may be made to corresponding descriptions of the corresponding steps in the embodiment of the channel configuration method, and details are not described herein again.

FIG. 5A is a schematic structural diagram of an embodiment of a user equipment according to this application. As shown in FIG. 5A, a user equipment 500 comprises: a channel configuration apparatus 51. The channel configuration apparatus 51 is the channel configuration apparatus described in Embodiment 1 of the channel configuration apparatus or Embodiment 2 of the channel configuration apparatus provided in this application.

In an example embodiment, the user equipment 500 is the reference device.

In another example embodiment, as shown in FIG. 5B, the user equipment 500 is an earphone device. The user equipment 500 further comprises: the two earpieces, that is, an earpiece 52 and an earpiece 53.

In this embodiment, the reference device may be any device whose bearing relative to the user body is known.

From a perspective that the reference device and the two earpieces work cooperatively, optionally, the reference device is an audio output device or an audio input device. Specifically, when the reference device is an audio output device, the reference device outputs, optionally according to channel configurations performed by the channel configuration apparatus 51 for the audio signals of the two earpieces, audio signals of a left channel and audio signals of a right channel from the two earpieces; or when the reference device is an audio input device, the reference device determines, optionally according to channel configurations performed by the channel configuration apparatus 51 for the audio signals of the two earpieces, which of the audio signals separately input from the two earpieces is audio signals of a left channel, and which one is audio signals of a right channel.

From a perspective of a device type, optionally, the reference device is a handheld device or a wearable device. Specifically, the handheld device comprises, but is not limited to: a mobile phone, a tablet computer, an MP3 player, or the like; and the wearable device comprises, but is not limited to: a smart wrist strap, smart glasses, or the like.

The user equipment of this embodiment provides a channel configuration solution: the channel configuration apparatus acquires at least one related attribute of a wireless communication distance from each of two earpieces in pair to a reference device; and performs a channel configuration on audio signals of the two earpieces at least according to the at least one related attribute of the wireless communication distance and a bearing of the reference device relative to a user body wearing the two earpieces.

A person of ordinary skill in the art may realize that, in combination with the examples described in the embodiments disclosed in this specification, units and method steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that such implementation goes beyond the scope of this application.

When the function is implemented in the form of a software functional unit and sold or used as an independent product, it may be stored in a computer-readable storage medium. Based on such an understanding, the technical solutions of this application essentially, or the part contributing to the prior art, or all or a part of the technical solutions may be implemented in the form of a software product. The software product is stored in a storage medium and comprises several instructions for instructing a computer device (which may be a personal computer, a server, a network device, or the like) to perform all or a part of the steps of the methods in the embodiments of this application. The foregoing storage medium comprises: any medium that can store program code, such as a USB flash drive, a removable hard disk, a read-only memory (ROM), a RAM, a magnetic disk, or an optical disc.

The above example embodiments are only used to describe this application, rather than limiting this application; various alterations and modifications can be made by those of ordinary skill in the art without departing from the spirit and scope of this application. Therefore, all equivalent technical solutions also belong to the scope of this application, and the patent protection scope of this application should be subject to the claims.

What is claimed is:

1. A method, comprising:
acquiring, by a system comprising a processor, at least one related attribute of a wireless communication distance from each of two earpieces in pair to a reference device; and
performing a channel configuration on audio signals of the two earpieces at least according to the at least one related attribute of the wireless communication distance and a bearing of the reference device determined relative to a user body wearing the two earpieces.

2. The method of claim 1, wherein the bearing of the reference device determined relative to the user body comprises: the reference device being determined to be located at a left side or a right side of the user body.

3. The method of claim 1, wherein the at least one related attribute of the wireless communication distance comprises at least one of a received signal strength indication relative to the same emission power, a round trip delay, or channel state information.

4. The method of claim 1, wherein the performing the channel configuration comprises:
in response to determining that the at least one related attribute of the wireless communication distance identifies that a first wireless communication distance from one earpiece in the two earpieces to the reference device is nearer than a second wireless communication distance from the other earpiece to the reference device, and the reference device being determined to be located at a left side of the user body, configuring an audio signal channel of the one earpiece as a left channel, and configuring another audio signal channel of the other earpiece as a right channel.

5. The method of claim 1, wherein the performing the channel configuration comprises:
in response to determining that the at least one related attribute of the wireless communication distance identifies that a first wireless communication distance from one earpiece in the two earpieces to the reference device is nearer than a second wireless communication distance from the other earpiece to the reference device, and the reference device being determined to be located at a right side of the user body, configuring an audio signal channel of the one earpiece as a right channel, and configuring another audio signal channel of the other earpiece as a left channel.

6. The method of claim 1, wherein the reference device is an audio output device or an audio input device.

7. An apparatus, comprising:
a memory that stores executable modules; and
a processor, couple to the memory, that executes or facilitates execution of the executable modules, the executable modules comprising:
an attribute acquisition module configured to acquire at least one related attribute of respective wireless communication distances from two earpieces in pair to a reference device; and
a channel configuration module configured to perform a channel configuration on audio signals of the two earpieces at least according to the at least one related attribute of the wireless communication distance and a bearing of the reference device determined relative to a user body wearing the two earpieces.

8. The apparatus of claim 7, wherein the bearing of the reference device determined relative to the user body comprises: the reference device being located at a left side or a right side of the user body.

9. The apparatus of claim 7, wherein the at least one related attribute of the wireless communication distance comprises at least one of a received signal strength indication relative to the same emission power, a round trip delay, or channel state information.

10. The apparatus of claim 7, wherein the channel configuration module comprises:
a first configuration unit configured to: in response to a determination that the at least one related attribute of the wireless communication distance identifies that a first wireless communication distance from one earpiece in the two earpieces to the reference device is nearer than a second wireless communication distance from the other earpiece to the reference device, and in response to a determination that the reference device is located at a left side of the user body, configure an audio signal channel of the one earpiece as a left channel, and configure another audio signal channel of the other earpiece as a right channel.

11. The apparatus of claim 7, wherein the channel configuration module comprises:
a second configuration unit configured to in response to a determination that the at least one related attribute of the wireless communication distance identifies that a first wireless communication distance from one earpiece in the two earpieces to the reference device is nearer than a second wireless communication distance from the other earpiece to the reference device, and in response to a determination that the reference device is located at a right side of the user body, configure an audio signal channel of the one earpiece as a right channel, and configure another audio signal channel of the other earpiece as a left channel.

12. The apparatus of claim 7, wherein the apparatus is a user equipment.

13. The apparatus of claim 12, wherein the user equipment is the reference device.

14. The apparatus of claim 12, wherein the user equipment is an earphone device, and the user equipment further comprises: the two earpieces.

15. The apparatus of claim 12, wherein the reference device is an audio output device or an audio input device.

16. The apparatus of claim 12, wherein the reference device is a handheld device or a wearable device.

17. A computer readable storage device comprising executable instructions that, in response to execution, cause a device comprising a processor to perform operations, comprising:
acquiring respective related attributes of respective wireless communication distances from two earpieces in pair to a reference device; and
performing a channel configuration on audio signals of the two earpieces at least according to the respective related attributes of the respective wireless communication distances and a bearing of the reference device relative to a user body wearing the two earpieces.

18. The computer readable storage device of claim 17, wherein the bearing of the reference device the reference device being determined to be located at a right side of the user body.

19. The computer readable storage device of claim 17, wherein the bearing of the reference device the reference device being determined to be located at a left side of the user body.

20. The computer readable storage device of claim 17, wherein the respective related attributes of respective wireless communication distances comprise at least one of a received signal strength indication relative to the same emission power, a round trip delay, or channel state information.
